(19) United States
(12) Patent Application Publication
(10) Pub. No.: US 2025/0276625 A1
(43) Pub. Date: Sep. 4, 2025

(54) BLOWER PROTECTION STRUCTURE OF A SEATBACK, AND VEHICLE SEAT

(71) Applicants: NHK SPRING CO., LTD., Yokohama-shi (JP); SUBARU CORPORATION, Tokyo (JP)

(72) Inventors: Kenzo YASUDA, Yokohama-shi (JP); Yoichi AOKI, Yokohama-shi (JP); Yosuke ISHIYAMA, Tokyo (JP); Masato FUKUSHIMA, Tokyo (JP)

(21) Appl. No.: 19/066,794

(22) Filed: Feb. 28, 2025

(30) Foreign Application Priority Data
Mar. 4, 2024 (JP) 2024-032467

(51) Int. Cl. B60N 2/56

(52) U.S. Cl. CPC B60N 2/5642

(57) ABSTRACT

A blower protection structure of a seatback has a pair of left and right lumbar wires spanning between an upper portion and a lower portion of a seatback frame of a vehicle seat, a blower mounted directly or indirectly to the left and right lumbar wires, and a fabric-like member disposed at a seatback rear side with respect to the blower and having a pair of left and right anchor portions anchored at the left and right lumbar wires.

### CROSS-REFERENCE TO RELATED APPLICATION

This application is based on and claims priority under 35 USC 119 from Japanese Patent Application No. 2024-032467, filed on Mar. 4, 2024, the disclosure of which is incorporated by reference herein.

### BACKGROUND

### Technical Field

The present disclosure relates to a vehicle seat, and in particular, to a blower protection structure of a seatback.

### Related Art

In the vehicle seat disclosed in Japanese Patent Application Laid-Open (JP-A) No. 2008-104769, a blowing unit that is built into the interior of a seatback is supported so as to be displaced in the direction of the back surface of the seatback by load applied from the front surface side. The backboard of the seatback has an opening at a position facing the blowing unit. The surface of the backboard is covered by a cover over the entirety thereof, including the opening. A protection sheet is provided integrally at the reverse surface of the cover at, of the opening that is covered by the cover, the region that is interfered with by displacement of the blowing unit in the direction toward the back surface.

### SUMMARY

In the above-described prior art technique, at the time when, for example, an occupant in a rear seat kicks the back surface of the seatback, the blowing unit can be protected by the protecting sheet, and therefore, damage to the blowing unit can be prevented or suppressed. However, because a process for making the protecting sheet integral with the cover is needed, there is room for improvement from the standpoint of facilitating manufacturing.

An object of the present disclosure is to provide a blower protection structure of a seatback and a vehicle seat that can protect a blower from impact load applied to the back surface of a seatback, and that are easily manufactured.

A blower protection structure of a seatback of a first aspect of the present disclosure has a pair of left and right lumbar wires spanning between an upper portion and a lower portion of a seatback frame of a vehicle seat, a blower mounted directly or indirectly to the left and right lumbar wires, and a fabric-like member disposed at a seatback rear side with respect to the blower and having a pair of left and right anchor portions anchored at the left and right lumbar wires.

In the blower protection structure of a seatback of the first aspect, the blower is mounted directly or indirectly to the pair of left and right lumbar wires that span between the upper portion and the lower portion of the seatback frame of a vehicle seat. The fabric-like member is disposed at the seatback rear side with respect to the blower. Due thereto, the blower can be protected from impact load applied to the back surface of the seatback. Moreover, the fabric-like member is attached to the left and right lumbar wires due to the left and right anchor portions of the fabric-like member being anchored at the left and right lumbar wires. Therefore, a process for making the cover of the seatback and the fabric-like member integral is unnecessary, and manufacturing is easy. Further, because the fabric-like member is used, it is easy to ensure the degrees of freedom in the designing and shaping of the back surface of the seatback.

In a blower protection structure of a seatback of a second aspect, in the first aspect, the left and right anchor portions are a pair of left and right through holes through which the left and right lumbar wires are inserted.

In the blower protection structure of a seatback of the second aspect, the fabric-like member is attached to the left and right lumbar wires due to the left and right lumbar wires being inserted through the left and right through holes of the fabric-like member. Therefore, the structure of the fabric-like member can be simplified.

In a blower protection structure of a seatback of a third aspect, in the first aspect or the second aspect, the fabric-like member is nipped between the blower and an upper bracket of the seatback frame.

In the blower protection structure of a seatback of the third aspect, the fabric-like member that is flexible is nipped between the blower and the upper bracket of the seatback frame. Due thereto, the blower can be prevented from directly hitting the upper bracket due to, for example, input at the time when an occupant kneels on the seatback that has been reclined. As a result, the generation of noise can be prevented.

In a blower protection structure of a seatback of a fourth aspect, in any one of the first aspect through the third aspect, an upper portion of the fabric-like member is formed such that, the further toward a seatback upper side, the narrower a seatback left-right direction dimension of the upper portion becomes.

In the blower protection structure of a seatback of the fourth aspect, because the upper portion of the fabric-like member is formed as described above, the fabric-like member can be prevented from interfering with the stays of the headrest for example. Further, in the case of a structure in which the fabric-like member is nipped between the blower and the upper bracket of the seatback frame as in the third aspect, it is easy to nip the fabric-like member in between the blower and the upper bracket at the time of manufacturing the vehicle seat.

In a blower protection structure of a seatback of a fifth aspect, in any one of the first aspect through the fourth aspect, a harness protecting portion, which covers, from the seatback rear side, a base portion of a harness of the blower, is provided at a lower portion of the fabric-like member.

In the blower protection structure of a seatback of the fifth aspect, the base portion of the harness of the blower is covered, from the seatback rear side, by the harness protecting portion provided at the lower portion of the fabric-like member. Therefore, the base portion of the harness can be protected by the fabric-like member.

A vehicle seat of a sixth aspect has a seat cushion on which an occupant sits, and a seatback supporting a back of the occupant, wherein the seatback has the blower protection structure of a seatback of any one of the first aspect through the fifth aspect.

In the vehicle seat of the sixth aspect, the back of the occupant seated on the seat cushion is supported by the seatback. Because this seatback has the blower protection structure of a seatback of any one of the first aspect through the fifth aspect, the above-described effects are achieved.

As described above, in accordance with the blower protection structure of a seatback and the vehicle seat relating to the present disclosure, a blower can be protected from impact load applied to the back surface of a seatback, and manufacturing is easy.

### BRIEF DESCRIPTION OF THE DRAWINGS

Exemplary embodiments of the present invention will be described in detail based on the following figures, wherein:

FIG. 1 is a side view illustrating a vehicle seat relating to a first embodiment;

FIG. 2 is a perspective view illustrating a portion of a seatback of the vehicle seat;

FIG. 3 is a first perspective view illustrating a portion of the structure illustrated in FIG. 2;

FIG. 4 is a second perspective view illustrating a portion of the structure illustrated in FIG. 2;

FIG. 5 is a perspective view illustrating portions of left and right lumbar wires and a fabric-like member;

FIG. 6 is a perspective view illustrating portions of the left and right lumbar wires;

FIG. 7 is a perspective view illustrating the fabric-like member;

FIG. 8 is a side view, corresponding to FIG. 1, for explaining load applied to a back surface of the seatback; and

FIG. 9 is a side view, corresponding to FIG. 1, for explaining load applied to the seatback that has been reclined.

### DETAILED DESCRIPTION

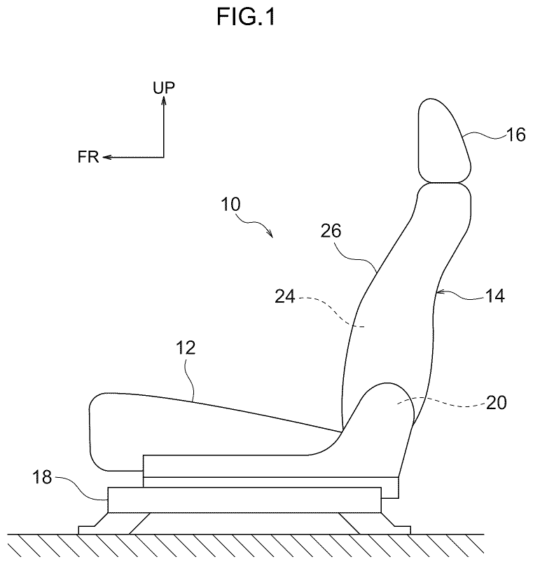

A vehicle seat 10 relating to a first embodiment of the present disclosure is described hereinafter with reference to FIG. 1 through FIG. 9. Note that, in the respective drawings, there are cases in which some of the reference numerals are omitted in order to make the drawings easier to understand. Further, arrows FR, LH, RH and UP that are shown appropriately in the respective drawings indicate the forward, leftward, rightward and upward of the vehicle seat 10, respectively. Hereinafter, when explanation is given by using merely front-rear, left-right and vertical directions, they refer to the directions with respect to the vehicle seat 10.

As illustrated in FIG. 1, the vehicle seat 10 relating to the present embodiment is, as an example, a front seat of a vehicle, and has a seat cushion 12 on which an occupant sits, a seatback 14 supporting the back of the occupant, and a headrest 16 supporting the head of the occupant. The seat cushion 12 is connected to the floor of the vehicle via a known sliding mechanism 18. The lower end portion of the seatback 14 is connected to the rear end portion of the seat cushion 12 via a known reclining mechanism 20. The headrest 16 is connected to the upper end portion of the seatback 14 such that the vertical position thereof is adjustable.

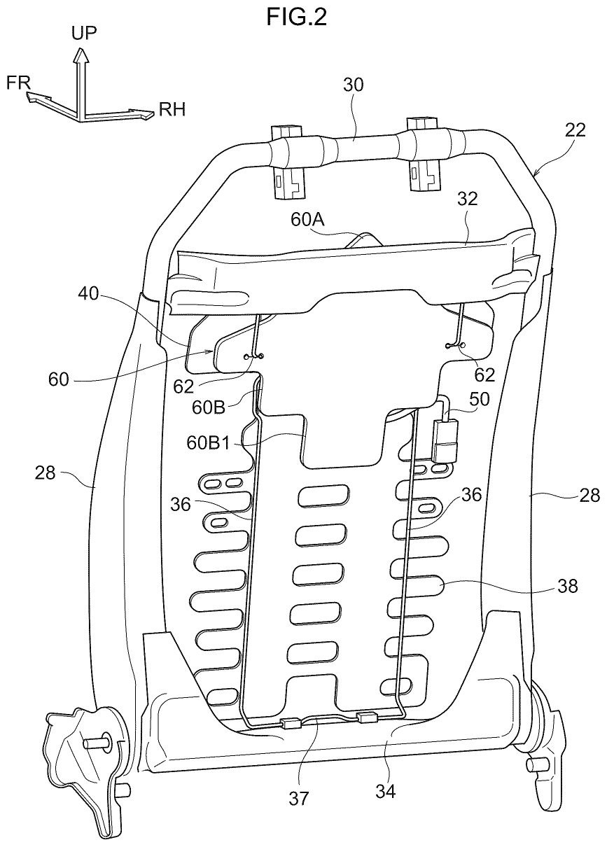

The seatback 14 has a seatback frame 22 (see FIG. 2 through FIG. 4) that is a frame member, a seatback pad 24 that is a cushion material, and a trim cover 26 that is a cover material. As illustrated in FIG. 2 through FIG. 4, the seatback frame 22 has a pair of left and right side frames 28, an upper frame 30 connecting the upper end portions of the left and right side frames 28 in the left-right direction, an upper bracket 32 mounted to the upper frame 30, and a lower frame 34 connecting the lower end portions of the left and right side frames 28 in the left-right direction.

The left and right side frames 28, the upper bracket 32 and the lower frame 34 are, for example, structured by plate members made of metal that have been press molded. The upper frame 30 is, for example, structured by a pipe member made of metal that has been bent. The upper frame 30 is formed in a substantially upside-down U shape as seen in the front-rear direction, and the upper bracket 32 spans between the left and right both end portions at the lower portion of the upper frame 30.

The seatback pad 24 is, for example, structured by a foamed body such as urethane foam, and is covered on the seatback frame 22 from the upper side thereof. The trim cover 26 is, for example, formed in the shape of a bag due to plural cover pieces formed from a fabric material, leather or synthetic leather being sewn together, and is covered on the seatback pad 24 from the upper side thereof.

A pair of left and right lumbar wires 36 span between the upper bracket 32 provided at the upper portion of the seatback frame 22 and the lower frame 34 provided at the lower end portion of the seatback 14. The left and right lumbar wires 36 extend in the vertical direction, and are disposed with an interval therebetween in the left-right direction. The lower end portions of the left and right lumbar wires 36 are connected in the left-right direction by a connecting wire 37, and the connecting wire 37 is fixed to the lower frame 34. The left and right lumbar wires 36 and the connecting wire 37 are, for example, structured integrally by a wire material made of metal.

A lumbar support plate 38 is mounted to the left and right lumbar wires 36 via an unillustrated lumbar support driving mechanism. The lumbar support plate 38 is, for example, structured by an injection-molded resin, and is formed substantially in the shape of a plate whose length direction is the vertical direction and whose thickness direction is the front-rear direction. This lumbar support plate 38 is disposed at the front sides of the left and right lumbar wires 36, and contacts the back surface of the seatback pad 24. The lumbar support driving mechanism displaces the lumbar support plate 38 in the front-rear direction by the driving force of a motor. Due thereto, the strength of supporting the lumbar region of the occupant is adjusted.

A mounting bracket 40 is disposed within the seatback 14, above the lumbar support plate 38. The mounting bracket 40 is, for example, structured in the shape of a plate from an injection-molded resin, and is formed substantially in the shape of a plate whose length direction is the left-right direction and whose thickness direction is the front-rear direction. The mounting bracket 40 is disposed at the front sides of the left and right lumbar wires 36, and is mounted to the left and right lumbar wires 36 via other wires that are not illustrated and the above-described lumbar support mechanism. Note that the mounting bracket 40 may be structured so as to be mounted directly to the left and right lumbar wires 36.

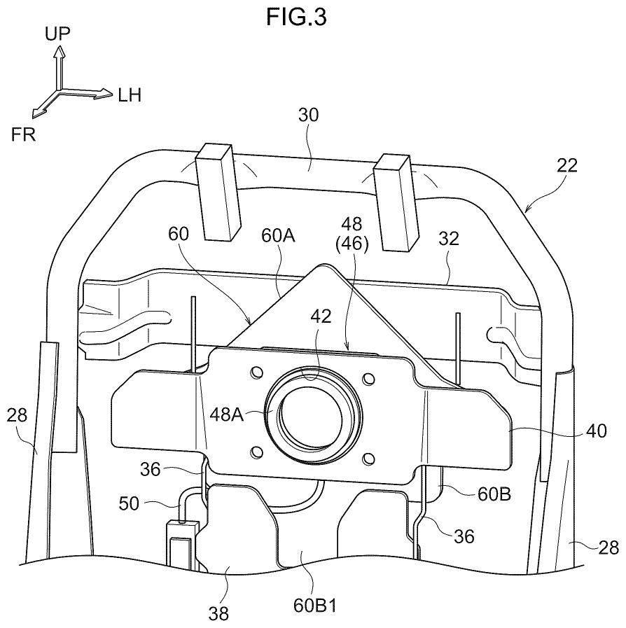

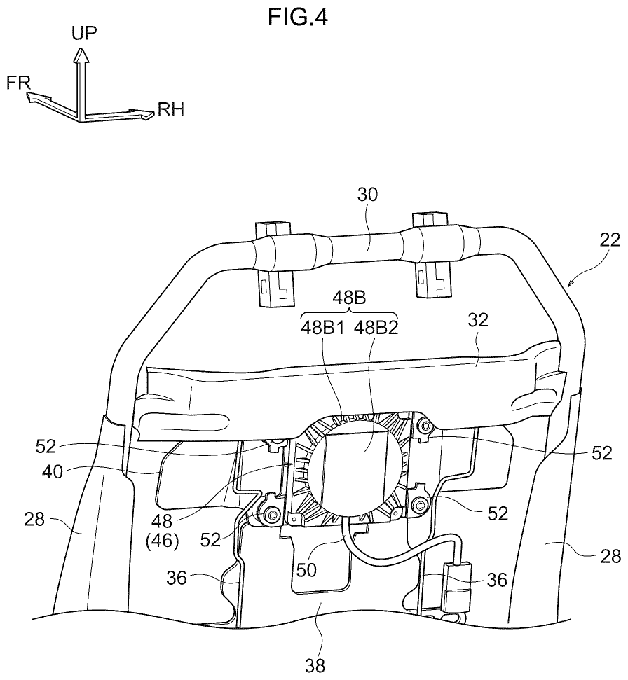

As illustrated in FIG. 3 and FIG. 4, a blower 46 is mounted to the left-right direction central portion of the mounting bracket 40. The blower 46 is disposed at the rear side of the mounting bracket 40, and is mounted indirectly to the left and right lumbar wires 36 via the mounting bracket 40, the aforementioned other wires, and the aforementioned lumbar support driving mechanism. Note that the blower 46 may be structured so as to be mounted directly to the left and right lumbar wires 36. The blower 46 is a centrifugal blower for example, and has an unillustrated turbo fan whose axial direction is the front-rear direction, and a case 48 that accommodates the turbo fan. The case 48 is, for example, structured from an injection-molded resin, and is formed in a quadrangular shape as seen from the front-rear direction, and is formed so as to be thin in the front-rear direction.

As illustrated in FIG. 3, a through-hole 42 that is circular is formed in the left-right direction central portion of the mounting bracket 40. An intake port 48A provided at the case 48 of the blower 46 is inserted in the through-hole 42. The intake port 48A is formed in the shape of a cylindrical tube whose axial direction is the front-rear direction, and is disposed so as to contact the back surface of the seatback pad 24. Although not illustrated, plural intake holes are formed in the seatback pad 24 at places facing the intake port 48A.

As illustrated in FIG. 4, a fan accommodating portion 48B, which is shaped as a cylindrical tube having a bottom and which has a cylindrical-tube-shaped peripheral wall portion 48B1 whose axial direction is the front-rear direction and a bottom wall portion 48B2, is provided at the rear portion of the case 48. The turbo fan is accommodated at the inner side of the peripheral wall portion 48B1, and the turbo fan is covered from the rear side by the bottom wall portion 48B2. Plural, unillustrated exhaust ports are formed in the peripheral wall portion 48B1.

An unillustrated motor that rotates the turbo fan is provided within the case 48. When the turbo fan is rotated by this motor, air at the front surface side (i.e., the occupant side) of the seatback 14 is drawn-in through the aforementioned plural intake holes into the intake port 48A, and is exhausted from the aforementioned plural exhaust ports. Note that 50 in FIG. 2 through FIG. 4 is a harness for supplying electric power to the aforementioned motor.

Two fastening pieces 52, one at the upper side and one at the lower side, are provided at each of the left end portion and the right end portion of the case 48. The respective fastening pieces 52 are formed in the shapes of plates whose thickness direction is the front-rear direction. Screw holes (no reference numeral) that are circular are formed in the central portions of the respective fastening pieces 52. Four fastening seats that are not illustrated are formed at the mounting bracket 40 so as to correspond to the four fastening pieces 52.

Unillustrated nuts are embedded within the respective fastening seats by insert molding for example. The respective fastening pieces 52 are superposed on the respective fastening seats from the rear side, and screws (no reference numeral) that are inserted into the screw holes of the respective fastening pieces 52 are screwed-together with the nuts of the respective fastening seats. The blower 46 is thereby mounted to the rear surface of the mounting bracket 40.

As illustrated in FIG. 2 and FIG. 3, a fabric-like member (blower protecting member) 60 is disposed within the seatback 14 at the rear side of the blower 46, and the blower 46 is covered from the rear side by the fabric-like member 60. Together with the left and right lumbar wires 36 and the blower 46, this fabric-like member 60 structures the “blower protection structure of a seatback” of the present disclosure. The fabric-like member 60 is formed in the shape of a sheet from a fabric-like material (e.g., felt), and is disposed in a posture in which the front-rear direction is the thickness direction thereof. Note that the material of the fabric-like member 60 is not limited to a fabric, and it suffices for it to be a sheet-shaped or a plate-shaped material that is flexible and impact-absorbent such as a thick fabric, and may be rubber or a foamed body.

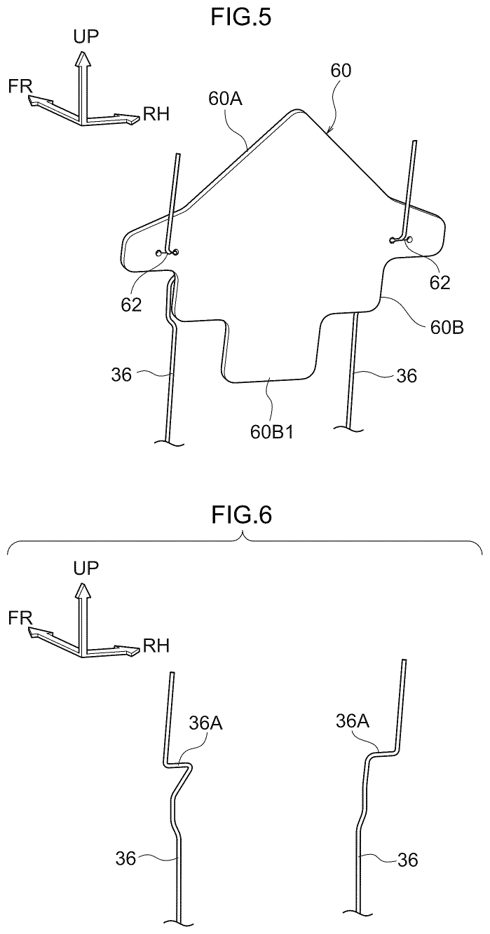

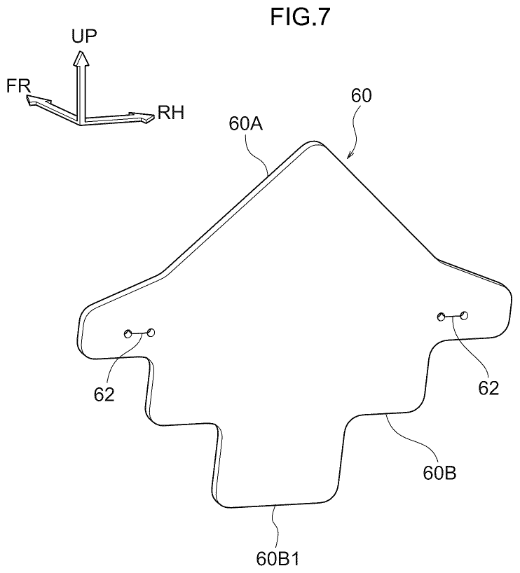

As illustrated in FIG. 5 and FIG. 7, an upper portion 60A of the fabric-like member 60 is formed substantially in the shape of a triangle as seen from the front-rear direction, and is formed such that, the further toward the upper side, the narrower the left-right direction dimension thereof becomes. Through holes 62 are formed in the left and right both end portions of the upper portion 60A of the fabric-like member 60. The left and right through holes 62 correspond to the “anchor portions” in the present disclosure.

The left and right through holes 62 pass-through the fabric-like member 60 in the front-rear direction, and are formed in the shapes of slits that extend in the left-right direction. As illustrated in FIG. 2 and FIG. 5, the upper portions of the left and right lumbar wires 36 are inserted-through the left and right through holes 62 from the front side. The fabric-like member 60 is thereby anchored at (attached to) the left and right lumbar wires 36. As illustrated in FIG. 6, bent portions 36A that are bent in crank shapes are formed at the upper portions of the left and right lumbar wires 36. Due to these bent portions 36A engaging with the edge portions of the through holes 62, displacement of the fabric-like member 60 toward the lower side with respect to the left and right lumbar wires 36 is restricted.

Note that, for example, instead of the left and right through holes 62, there may be a structure in which a pair of left and right resin clips serving as the pair of left and right anchor portions are attached to the fabric-like member 60 by means such as sewing, and the fabric-like member 60 is anchored at the left and right lumbar wires 36 by using these resin clips.

As illustrated in FIG. 2 and FIG. 3, the upper portion 60A of the fabric-like member 60 is nipped between the blower 46 and the upper bracket 32 of the seatback frame 22. The upper end portion of the fabric-like member 60 protrudes-out further toward the upper side than the upper bracket 32. As illustrated in FIG. 2, FIG. 5 and FIG. 7, lower portion 60B of the fabric-like member 60 is formed in a substantial T-shape as seen from the front-rear direction. A harness protecting portion 60B1, which covers, from the rear side, the base portion of the harness 50 that extends-out from the lower end portion of the blower 46, is provided at the lower portion of the fabric-like member 60.

In the vehicle seat 10 of the above-described structure, the back of the occupant seated on the seat cushion 12 is supported by the seatback 14. In the blower protection structure of a seatback that this seatback 14 has, the blower 46 is indirectly mounted to the pair of left and right lumbar wires 36 that span between the upper portion and the lower portion of the seatback frame 22. The fabric-like member 60 is disposed at the rear side of the blower 46.

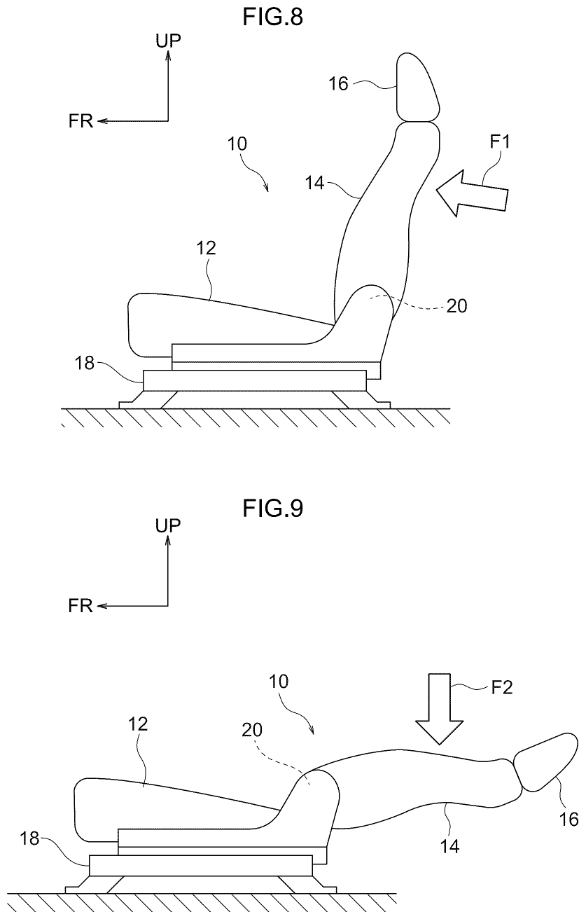

Therefore, for example, in a case in which an occupant in an unillustrated rear seat kicks the back surface of the seatback 14, and an impact load (refer to arrow F1 in FIG. 8) is applied to the back surface of the seatback 14 from the rear side thereof, the blower 46 can be protected from the rear side by above-described fabric-like member 60, and the impact applied to the blower 46 can be mitigated. As a result, due thereto, breakage of the blower 46 itself, and of the mounted-together portions of the blower 46 and the mounting bracket 40, can be prevented. As a result, the blower 46 drawing-in secondary air due to the blower 46 moving apart from the mounting bracket 40, and an increase in noise of the blower 46, can be avoided.

Moreover, the fabric-like member 60 is attached to the left and right lumbar wires 36 due to the left and right lumbar wires 36 being inserted-through the left and right through holes 62 of the fabric-like member 60. Therefore, a process for making the trim cover 26, which is the cover material of the seatback 14, and the fabric-like member 60 integral is unnecessary, and manufacturing is easy. Further, because the fabric-like member 60 that is flexible is used, it is easy to ensure the degrees of freedom in the designing and shaping of the back surface of the seatback 14.

Further, the fabric-like member 60 is attached to the left and right lumbar wires 36 due to the left and right lumbar wires 36 being inserted-through the left and right through holes 62 of the fabric-like member 60. Therefore, the structure of the fabric-like member 60 can be simplified as compared with, for example, a structure in which resin clips are attached to the fabric-like member 60.

Moreover, in the present embodiment, the fabric-like member 60 that is flexible is nipped between the blower 46 and the upper bracket 32 of the seatback frame 22. Due thereto, positional offset of the fabric-like member 60 can be prevented or suppressed. Further, the blower 46 can be prevented from directly hitting the upper bracket 32 due to, for example, input (refer to arrow F2 in FIG. 9) at the time when an occupant kneels on the seatback 14 that has been reclined. As a result, the generation of noise can be prevented.

Further, in the present embodiment, the upper portion 60A of the fabric-like member 60 is formed such that, the further toward the upper side, the narrower the left-right direction dimension thereof becomes, and is formed in a substantially triangular shape as seen in the front-rear direction. Therefore, it is easy for the fabric-like member 60 to be nipped-in between the upper bracket 32 and the blower 46 at the time of manufacturing the vehicle seat 10. Further, the fabric-like member 60 can be prevented from interfering with unillustrated stays of the headrest 16.

Further, in the present embodiment, the harness protecting portion 60B1, which covers, from the rear side, the base portion of the harness 50 of the blower 46, is provided at the lower portion 60B of the fabric-like member 60. Therefore, the base portion of the harness 50 can be protected by the fabric-like member 60.

Note that, although the above-described embodiment is structured such that the fabric-like member 60 is nipped between the blower 46 and the upper bracket 32 of the seatback frame 22, the present disclosure is not limited to this, and may be structured such that the fabric-like member is not nipped between the blower and the upper bracket.

Further, the above-described embodiment is structured such that the upper portion 60A of the fabric-like member 60 is formed such that, the further toward the upper side, the narrower the left-right direction dimension thereof becomes, but the present disclosure is not limited to this, and the shape of the fabric-like member can be changed appropriately.

Further, although the above-described embodiment is structured such that the harness protecting portion 60B1 is provided at the lower portion 60B of the fabric-like member 60, the present disclosure is not limited to this, and may be structured such that the harness protecting portion is omitted.

In addition, the present disclosure can be implemented by being modified in various ways within a scope that does not depart from the gist thereof. Further, the scope of the right of the present disclosure is, of course, not limited by the above-described embodiments.

What is claimed is:

1. A blower protection structure of a seatback, comprising:
a pair of left and right lumbar wires spanning between an upper portion and a lower portion of a seatback frame of a vehicle seat;
a blower mounted directly or indirectly to the left and right lumbar wires; and
a fabric-like member disposed at a seatback rear side with respect to the blower, and having a pair of left and right anchor portions anchored at the left and right lumbar wires.

2. The blower protection structure of a seatback of claim 1, wherein the left and right anchor portions are a pair of left and right through holes through which the left and right lumbar wires are inserted.

3. The blower protection structure of a seatback of claim 1, wherein the fabric-like member is nipped between the blower and an upper bracket of the seatback frame.

4. The blower protection structure of a seatback of claim 1, wherein an upper portion of the fabric-like member is formed such that, the further toward a seatback upper side, the narrower a seatback left-right direction dimension of the upper portion becomes.

5. The blower protection structure of a seatback of claim 1, wherein a harness protection portion, which covers, from the seatback rear side, a base portion of a harness of the blower, is provided at a lower portion of the fabric-like member.

6. A vehicle seat, comprising:
a seat cushion on which an occupant sits; and
a seatback supporting a back of the occupant,
wherein the seatback has the blower protection structure of a seatback of claim 1.
